(19) United States
(12) Patent Application Publication
(10) Pub. No.: US 2025/0275834 A1
(43) Pub. Date: Sep. 4, 2025

(54) SYSTEM, METHOD, AND PALATAL EXPANSION SUPPORT KIT FOR TREATING ORTHODONTIC MISALIGNMENT IN USERS

(71) Applicants: Gregory Robert Baker, Hazard, KY (US); Derek Gene Watts, Leburn, KY (US)

(72) Inventors: Gregory Robert Baker, Hazard, KY (US); Derek Gene Watts, Leburn, KY (US)

(21) Appl. No.: 19/206,279

(22) Filed: May 13, 2025

(51) Int. Cl. A61C 7/10; A61C 7/02; A61C 19/04

(52) U.S. Cl. CPC A61C 7/10; A61C 7/02; A61C 19/04

(57) ABSTRACT

A palatal expansion support kit is provided for use in conjunction with a palatal expansion device installed in an upper jaw. The kit includes a mouth scanner sized and shaped for placement into an oral cavity of a patient to allow the patient to bite on it for capturing distal and lateral length readings of the upper jaw. The kit further includes a central console communicatively coupled to the mouth scanner. The central console is adapted to receive the readings of the upper jaw, transmit the received readings to an orthodontist for review, and receive necessary instructions on a course of treatment from the orthodontist. The central console further displays informational data over a display screen. The kit further includes a key adapted to adjust the palatal expansion device for correcting the upper jaw's misalignment.

### FIELD OF THE INVENTION

The present invention relates to the field of dental and orthodontic appliances, particularly to a new and improved palatal expansion support kit to be used in combination with conventional palatal expansion devices. The present invention relates to a palatal expansion support kit or a system and method for treating orthodontic misalignment in users. The present invention allows a user to consistently monitor palatal expansion during ongoing treatment, scan the lateral and distal lengths of the maxilla to determine needed expansion, make precise adjustments to the palatal expansion device all by themselves (based on feedback from an orthodontist) using an easy-to-operate key, and consult with the orthodontist as a follow-up routine.

### BACKGROUND

The global palatal expander market was valued at USD 631 million in 2024 and is projected to reach USD 678.96 million by 2033, demonstrating a growth of 7.6% annually during the forecast period (2025-2033) (source: SKU ID: 26045151, Global Growth Insight)

A crossbite is one of the most prevalent forms of orthodontic misalignment in the world today, and especially in the United States, where palatal expanders are being widely used. A crossbite may be a dental crossbite that arises from dental malposition. Dental crossbite is a specific kind of orthodontic misalignment wherein the teeth in the upper arch overlap with the teeth in the lower arch. Further, a crossbite may be a skeletal crossbite attributed to an issue with bone development. In such cases, there is an inadequate development of the upper jaw, causing it to be smaller or narrower than the lower jaw. As a result, the upper teeth end up positioned inside the lower teeth. The skeletal crossbite is a common problem found in children and adults.

The upper jaw, or maxilla, may include maxillary bones, which are fused at an intermaxillary suture. Orthodontic treatments available for correcting such crossbites (skeletal crossbites) commonly include expansion of the upper jaw using well-known palatal expansion devices, such as one shown in FIG. 1. The circumference of a palate may be expanded by use of such palatal expansion device. Widening the circumference of the palate increases the perimeter of the dental arch to create more space for teeth growth, thus preventing crossbites.

Palatal expansion may be performed for a number of purposes, including correcting narrow palates, preventing teeth crowding, fixing crossbite, and/or aligning the lower and upper teeth. As a known procedure, palatal expansion devices may be fitted over teeth in the upper jaw (as seen in FIG. 1) or be surgically embedded into the palate. The palatal expansion device may then be activated to create a force between the palatal bones. Over time, the two palatal bones move apart and the jaw widens. Orthodontists may leave the appliance in for a few months after the desired expansion is achieved to allow new bone to form. Such palate expansion treatment may take between 3 to 6 months depending upon the severity of the cases.

Although the use of palatal expansion devices such as those shown in FIG. 1 is common and accepted worldwide, such palatal expansion devices are prone to user error. The user may under or overexpand the palatal expansion devices. The under or overexpansion may contribute to pain and increased treatment time. Therefore, what is desired is an artificial palatal expansion kit that can be used together with the installed conventional palatal expansion devices, such as one shown in FIG. 1 to continuously monitor the results, self-adjust the palatal expansion device by users (based on prescription from an orthodontist) using an easy-to-operate key.

### SUMMARY

It is an objective of the present invention to provide a system, method, or a support kit that helps in treating a maxillary deficiency in a patient with accuracy by minimizing user errors, especially restricting the users from under or over-expanding the palatal expansion devices that may contribute to pain and increased treatment time.

The present invention allows a user to consistently monitor palatal expansion during ongoing treatment, scan the lateral and distal lengths of the maxilla to determine needed expansion, make precise adjustments to the palatal expansion device by themselves (based on prescription from an orthodontist) using an easy-to-operate key, and consult with the orthodontist as a follow-up routine.

It is an objective of the present invention to provide an easy-to-use home-based solution for users to self-adjust their palatal expander from the comfort of their home, depending upon instructions received from the orthodontist on number of turns the adjustment needs to be made.

It is an objective of the present invention to provide extended assistance to children because palatal expanders are often recommended for children because their bones are still developing, making it easier to adjust the jaw. However, some adults may also benefit from them in specific cases. Common reasons for needing a palatal expander include: Crowded teeth due to a lack of space, Crossbites, where the upper teeth bite inside the lower teeth, and breathing issues caused by a narrow upper jaw.

The present invention provides a solution in the form of a palatal expansion support kit that includes a mouth scanner, a central console, and a key that can locate holes on a screw and turn the screw of the palatal expansion device for desired expansion. The mouth scanner enables a user to calculate the extreme distance between the two ends of the upper jaw to determine the corrective adjustment required for expansion of the upper jaw in order to correct maxillary deficiency. The central console is the heart of the kit that's fed with the data captured by the mouth scanner. The central console is further able to communicate with an application server that is communicatively linked to an electronic device of an orthodontist. The central console is enabled with two-way communication with the electronic device of the orthodontist because of which, at least the scanned data related to upper jaw's lateral and distal lengths, any issues related to under or over-expanding of the palatal expansion device, information on expander device's breakage or becoming loose, and so on are transmitted to the orthodontist via the application server/cloud server. The orthodontist is able to review any data or information from user's end about any issues the patient is facing, information on target adjustment required, adjustment already achieved, so on and then relay the feedback or prescription or information to the user on number of turns the screw of the palatal expansion device needs to be turned to meet the targeted expansion of the upper jaw, instruction on how to fix the loosen device and so on. The key is another essential component of the kit designed to provide controlled rotation to the screw with ease of operation compared to conventional keys that are in use with the conventional palatal expansion devices. Compared to conventional keys, the proposed key is spring loaded and due to this, on every adjustment/push, a pinion connected to a hole on the screw rotates the screw to a quarter of a turn (¼ mm).

These and other features and advantages of the present invention will become apparent from the detailed description below, in light of the accompanying drawings.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a conventional palatal expansion device installed in a maxilla or an upper jaw for correcting upper jaw deficiency.

FIG. 2 illustrates an exploded view of a palatal expansion support kit, according to an exemplary embodiment.

FIGS. 3A-3B show a three-layer configuration of a mouth scanner of the palatal expansion support kit of FIG. 2.

FIG. 4 shows an exploded view of a key adapted for turning a screw of the conventional palatal expansion device installed in the maxilla or the upper jaw.

FIGS. 5A-5C show the key and movement of spring-loaded handle and pinion, according to an embodiment.

FIG. 6 shows a use case scenario of the key with respect to the screw of the palatal expansion device, according to an embodiment.

FIG. 7 shows the screw connecting the two brackets of the palatal expansion device of FIG. 1, wherein the screw includes four holes for connecting pinion of the key.

FIG. 8 shows a schematic diagram involving a patient, a palatal expansion support kit of FIG. 2, an orthodontist, and a two-way communication between them.

FIG. 9 shows an exemplary screen outlook of a central console and the exemplary data/information rendered on it.

### DETAILED DESCRIPTION

The following description is of exemplary embodiments of the invention only and is not intended to limit the scope, applicability, or configuration of the invention. Rather, the following description is intended to provide a convenient illustration for implementing various embodiments of the invention. As will become apparent, various changes may be made in the function and arrangement of the elements described in these embodiments without departing from the scope of the invention as set forth herein. It should be appreciated that the description herein may be adapted to be employed with alternatively configured devices having different shapes, components, attachment mechanisms and the like and still fall within the scope of the present invention. Thus, the detailed description herein is presented for purposes of illustration only and not for limitation.

Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. In the context of present invention, the terms “dental expansion,” and “orthodontic expansion,” “palatal expansion,” etc, are interchangeably used in this disclosure. Likewise, the terms “dental alignment,”, “orthodontic alignment,” etc. are interchangeably used throughout this disclosure.

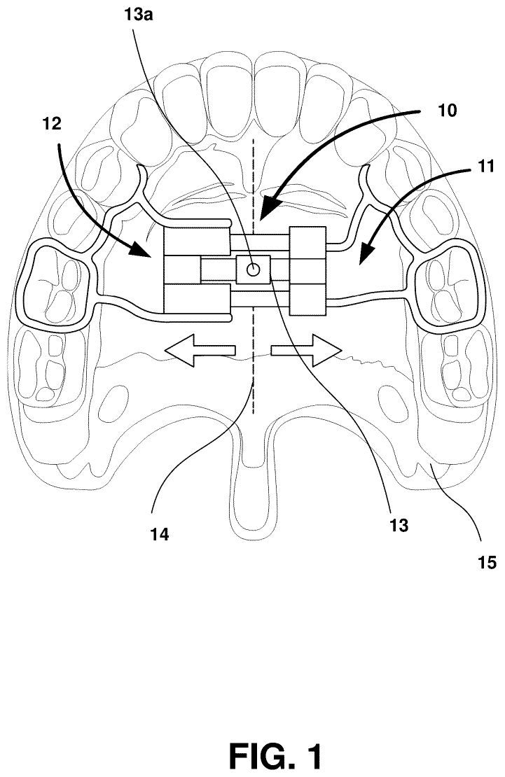

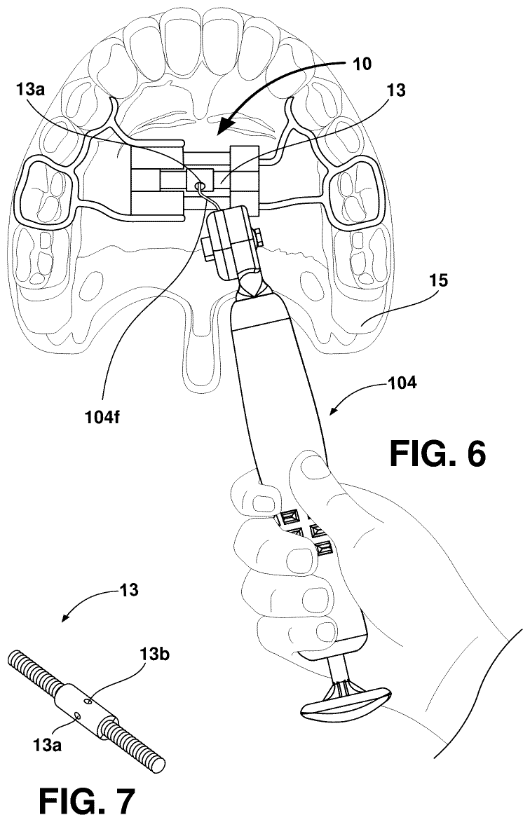

The palatal expansion support kit, or a system and method for treating orthodontic misalignment in users undergoing upper jaw expansion using conventional palatal expansion device, will now be described with reference to accompanying drawings, particularly FIGS. 1-9.

Reference is initially made to FIG. 1 that shows a basic structure of the conventional palatal expander or expansion device 10. As known, a palatal expander 10 is an orthodontic device designed to widen the upper jaw. It helps create more space in the mouth by gradually expanding the roof of the mouth or palate. The palatal expander 10 addresses crowding, crossbites, and other alignment issues. The main goal is to improve how teeth fit together and make room for proper growth. The process involves a gentle, steady pressure applied to the upper jaw over time. The expander 10 is adjusted daily or weekly, depending on the orthodontist's instructions. This pressure encourages the two halves (on either side of the suture) of the upper jaw to move apart, creating extra room. Once the desired width is achieved, the expander stays in place for a while to allow the bone to stabilize. As seen in FIG. 1, the palatal expansion device or palatal expander 10 includes two brackets 11,12 connected by a screw 13. The screw 13 when turned leads to expansion of brackets 11,12. When there is expansion of brackets 11,12, then the suture 14 in the maxilla or upper jaw (jaw formed from the fusion of two maxillary bones) tears apart, correcting the entire arch of the upper jaw 15. Typically, this process is carried out gradually by the orthodontist by turning the screw to move the brackets 11,12 apart. DynaFlex, Fostadent, US Dental Depot, Ads Dental Lab, etc., are some of the companies that are involved in developing a palatal expander or expansion device 10 shown in FIG. 1 or a similar device. The current invention provides a solution in the form of a palatal expansion kit 100 that helps reduce the time the orthodontist spends correcting upper jaw misalignment during treatment. This is primarily achieved by enabling the user/patient to self-adjust the expander device 10 to correct the upper jaw's misalignment, continuously observe the progress of corrections, share the progress results with the orthodontist for necessary feedback, get an appointment and support from the orthodontist when there is a pain or any physical assistance form the orthodontist is required.

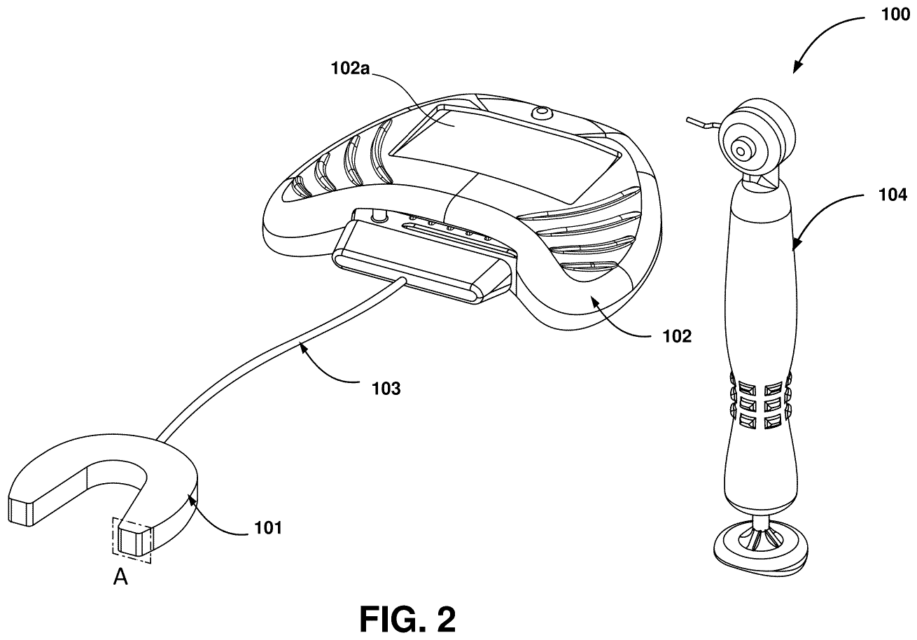

Referring to FIG. 2 illustrates an exploded view of a palatal expansion support kit, according to an exemplary embodiment. The palatal expansion support kit 100 includes a mouth scanner 101, a central console 102 communicatively coupled to the mouth scanner 101 via a connector or connecting cable 103, and a key 104.

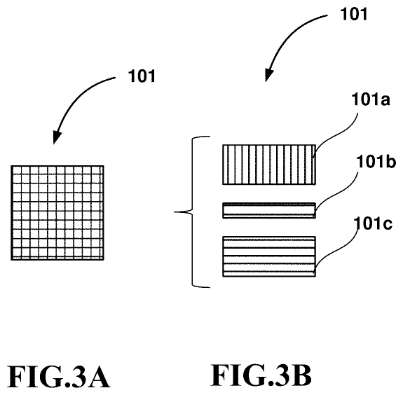

The mouth scanner 101 is shaped and sized for placement into the oral cavity of a user/patient to capture the jaw imprint, specifically an upper jaw imprint. It is parabolic-shaped or U-shaped in line with the shape of the upper law 15. The mouth scanner 101 acts as a bite pad. The mouth scanner 101 consists of three layers as seen in FIGS. 3A-3B taken along ‘A’ of FIG. 2, a flexible PCB layer 101a with copper traces in a gridline, a velostat 101b, and a rigid PCB layer 101c with complementary copper traces in a gridline. Combined, the three layers form the structure of gridlines with the velostat 101b. The scanner 101 captures the pressure points through resistances, generated from a moderate bite force of the user to create a digital imprint in the form of a heatmap, which is relayed on a screen 102a provided on the central console 102. The scanner 101 effectively produces data for analysis, such as the lateral and distal lengths of the jaw 13, and captures minute changes in them made through adjustments using the key 104. The scanner 101 may be used multiple times, after each session or as recommended by the orthodontist.

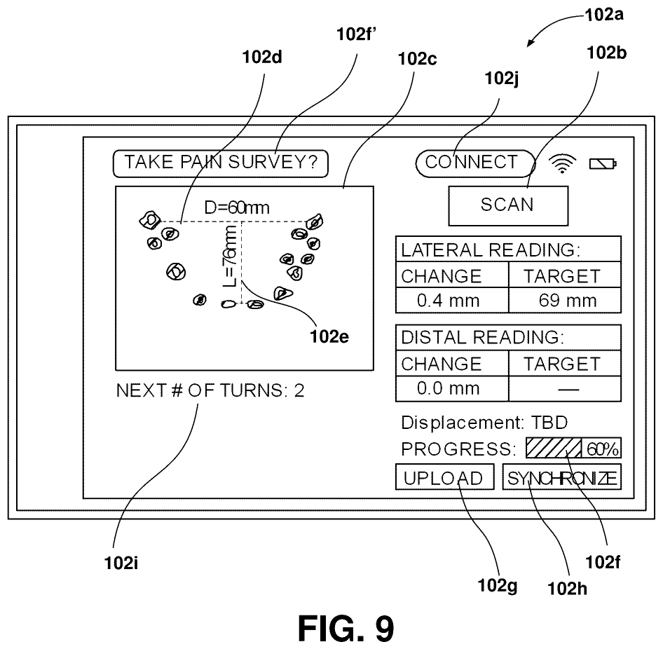

The central console 102 is the heart of the proposed system 100. The central console 102 is a hardware device with the ability to receive and process the scanned data received from the mouth scanner 101. In other words, the lateral and distal lengths of the upper jaw 15 captured by the mouth scanner 101 are received by the central console 102. Further, any minute changes made in the expander device 10 through adjustments using the key 104 are also communicated to the central console 102 by the mouth scanner 101 through the provided connectivity (e.g., connecting cable 103). The information/data received by the central console 102 are processed and displayed on a display screen. The display screen may be an infographic LCD/LED panel (FIG. 9) to show the latest recordings, target readings, latest consultation from the orthodontist on the number of turns to be made, capture pain surveys from the users to ensure what level of pain is experienced by the user/patient after the prior adjustment was made. The central console 102 may be powered by a Li-ion battery or powered from an AC power outlet at home. In an embodiment, once charged, the central console 102 can retain power for over 24 hours. The console 102 is enabled to connect to a WiFi/Hotspot or other communication network to upload data or information to a cloud server 105 for the orthodontist 111 to access the latest readings. This will be explained in the description to follow.

The central console 102 is connected to the mouth scanner 101 using a connector 103 (FIG. 2). The connector 103 is a two-sided connector preferably a connecting cable. The connector 103 relays data (the upper jaw's digital imprint) captured by the mouth scanner 101 to the central console 102. The connector 103 may be detached before and after the scanning is done by the mouth scanner 101. In some other embodiment (not seen), the mouth scanner 101 may be configured to wirelessly connect to the central console 102. In such an embodiment, the mouth scanner 101 may embody a wireless communication module to allow wireless connectivity.

Next, the palatal expansion support kit 100 further includes a key 104. The key 104 is an improved key over the traditional palatal expander keys in use. Examples of traditional palatal expander keys include for example, Galvanox Dental Orthodontic Expansion Swivel Key. Such traditional expander keys have a free movement of the pinions and adjusting it to the correct angle requires significant skills to meet a hole 13a (FIG. 1) provided on the screw 13 of the expander 10 and then turn to the right direction to complete an effective adjustment. A correct adjustment must expose the next hole 13b, 13c, 13d (considering the screw 13 comprises 4 holes, FIG. 1) and one complete turn of the screw requires four adjustments.

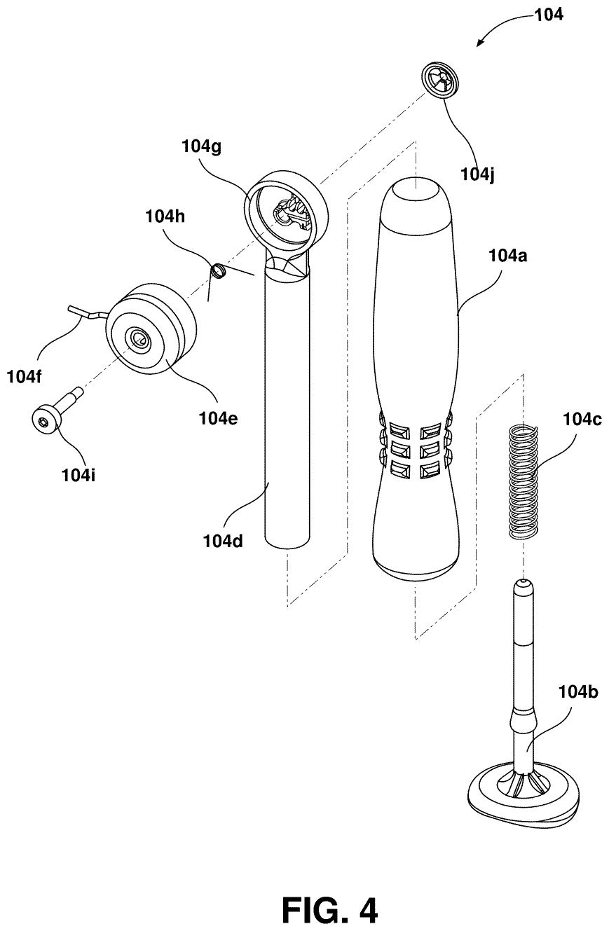

The proposed key 104 on the other hand is an improvement on the traditional key because the key 104 limits the span of the rectilinear and rotational motions of the pinion 104f, ensuring a successful adjustment with each application or use. The key 104 prevents negative adjustments (turning on the reverse directions) and ensures the pinion 104f holds a mean position for easy insertion each time. The constructional features and working mechanism of the proposed key 104 will now be explained with respect to FIGS. 4-7. Referring to FIGS. 4-7, the key 104 comprises an outer casing 104a, a handle 104b, an inner shaft 104d, a wheel 104c with pinion 104f, a shoulder screw 104i, a torsion spring 104h, a linear spring 104c, a retaining ring 104g and a screw nut 104j. The assembly is indicated by broken lines that show how these components connect. In assembly, the inner shaft 104d with the retaining ring 104g goes inside the outer casing 104. The handle 104b is loaded with the spring 104c and inserted inside the casing 104a to operationally connect the inner shaft 104d to the spring-loaded handle 104b. The wheel 104c with the pinion 104f and torsion spring 104h is housed within the retaining ring 104f and are secured inside the retaining ring 104 using the shoulder screw 104i, and the screw nut 104j.

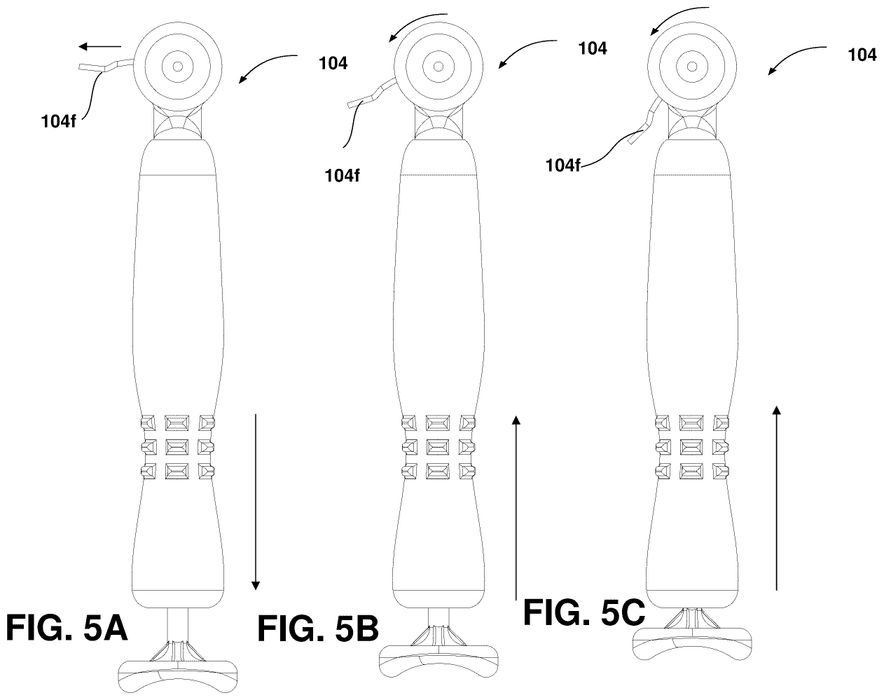

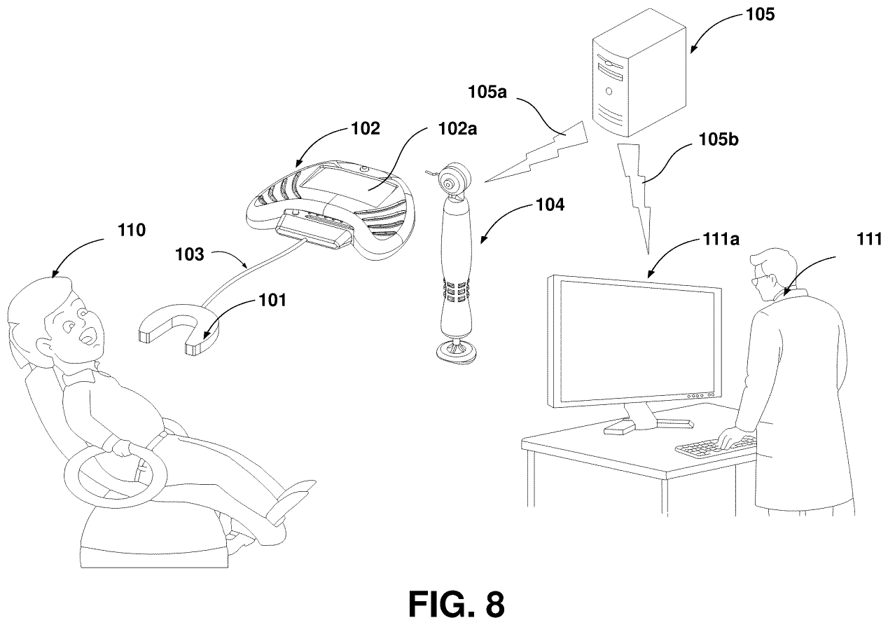

In operation, referring to FIGS. 5A-5C, 6 and 7, initially, the pinion 104f holds a mean position (FIG. 5A). The user locates a hole (say 13b) on the screw 13 and inserts a tip of the pinion 104f within the hole 13b and then pushes the handle 104b linearly producing rectilinear motion (FIGS. 5B-5C). The spring 104c restricts the movement to a defined distance. When the user pushes the handle 104b, the inner shaft 104c is moved as well, thereby rotating the pinion 104f (against the hole 103b) configured in the wheel 104c. The pushing force of the pinion 104f within the hole 13b rotates the screw 13 a quarter of a turn. After a single adjustment is made (quarter of a turn), the user releases his hand form the handle 104b, and this retracts the pinion 104f back to its mean position thereby making it ready for insertion inside next hole 13a on the screw 13. The user can then again push the handle 104b to make another quarter of a turn (next adjustment), and release the push action (as shown in FIG. 5A) on the handle 104b to get into the next hole 13d (not seen) for further adjustment, and so on. Each application or each time the user pushes/releases the handle 104b to make a quarter of a turn, the palatal expander 10 expands the upper jaw 15 by ¼ mm. Thus, in an example scenario, if the upper jaw's targeted adjustment needed is of say 60 mm (as determined by an orthodontist) and the current scanned result from the mouth scanner 101 shows 50 mm, then the required adjustment for the upper jaw 15 in order to correct the palatal disfunction to avoid crossbite or defects would be of 10 mm. To expand the expander device 10 by 10 mm, the screw 13 needs to make 10 complete turns. For this, the user is required to make 40 adjustments using the key 104 in the time interval advised by the orthodontist (say 6-12 months). The process shall be explained in more detail with respect to FIG. 8 in the description to follow.

Referring to FIG. 8, a schematic diagram involving a patient 110, a palatal expansion support kit 100 of FIG. 2 (the mouth scanner 101, the central console 102, and the key 104), an orthodontist 111, and a two-way communication between them is shown. FIG. 8 specifically shows how the kit 100 and the surrounding resources help the user 110 to self-use the kit 100 for making necessary upper jaw 15 adjustments. The working of the palatal expansion support kit 100, how the kit 100 can be used by a user or patient 110 at the comfort of the user's home, and by an orthodontist 111 will now be explained in detail. As seen, the user/patient 110 (child or adult) initially makes use of the biting pad or the mouth scanner 101. The user 100 inserts the mouth scanner 101 inside his oral cavity and then firmly bites onto the mouth scanner 101. Upon biting onto the mouth scanner 101, a digital imprint (as seen in FIG. 9) of the upper jaw 15 is captured by the scanner 101. This captured digital imprint estimates distal and lateral readings of the upper jaw 15. The captured data related to the distal and lateral distance of the upper jaw 15 is then fed to the central console 102 via the connector 103. The central console 102 then displays these distal and lateral readings in an infographic LCD panel 102a. The captured data from the mouth scanner 101 that arrives at the central console 102 is wirelessly (using wireless communication link 105a) communicated to an application server or a cloud server 105. The wireless communication is preferably a WiFi network. Once the data from the central console 102 is communicated to the server 105. The data or information is then relayed to an orthodontist 111 over a wireless communication link 105b. The orthodontist 111 can use a communication device 111b associated with him (Eg, Computer) to access and communicate data to the cloud server 105. The data is then transmitted back to the central console 102, which displays information to the user 110 for informational purposes or the next course of action.

Considering an exemplary scenario for the information displayed on the infographic LCD panel 102a in FIG. 9 in conjunction with FIG. 8, the patient 110 first bites on the bite pad or mouth scanner 101, and the captured data is transmitted to the central console 102. The captured digital imprint 102d is displayed within a window 102 of the central console 102. The digital imprint 102d primarily includes lateral and distal distances of the upper jaw 15. In the shown example, the distal distance is captured as 60 mm and the lateral distance as 76 mm. This data is communicated to the orthodontist 111 via the server 105. Based on estimates made by the central console 102, the infographic LCD panel 102a displays targeted lateral and distal distances. In the example shown, the targeted lateral distance is set to 69 mm, which is 9 mm more than the actual latest reading of 60 mm. Thus, the expander device 10 is supposed to expand by 9 mm. The orthodontist 111, upon receiving all the data from central console 102 communicates to the user/patient 110 about the frequency of adjustments and time estimates for necessary upper jaw correction. In the current example, 9 mm corrections may be achieved by 36 quarter turns or 9 full turns of the screw 13. The instruction communicated by the orthodontist 111 about the next date and the next number of turns 102i are displayed on the infographic LCD panel 102a. The infographic LCD panel 102a further shows treatment progress 102f. This could be in percentage and an approximate number of days required for the adjustment to be completed. The panel 102a also allows the user 110 to initiate a new scan by clicking on the scan button 102b. The panel 102a further allows the user/patient 110 to upload 102g the scanned data to the server 105, which is then shared with the orthodontist 111. The data displayed is also synchronized using a synchronization button 102h. The panel 102a also shows WiFi connectivity and battery level. The user 110 is enabled to connect to WiFi if the central console 102 is not already connected to WiFi by using the connect button 102j. The panel 102a also allows the user/patient 102 to take the pain survey 102f if the user experiences the pain during treatment. This then sends messages to the orthodontist 111 for taking an appointment to chat.

Finally, while the present invention has been described above with reference to various exemplary embodiments, many changes, combinations, and modifications may be made to the exemplary embodiments without departing from the scope of the present invention. For example, the various components may be implemented in alternative ways. These alternatives can be suitably selected depending upon the particular application or in consideration of any number of factors associated with the operation of the device. In addition, the techniques described herein may be extended or modified for use with other types of devices. These and other changes or modifications are intended to be included within the scope of the present invention.

What is claimed is:

1. A palatal expansion support kit (100) adapted for use in conjunction with a palatal expansion device (10) installed in an upper jaw (15), the palatal expansion support kit (100) comprising:
a mouth scanner (101) sized and shaped for placement into an oral cavity of a patient (110) for capturing distal and lateral length readings of the upper jaw (15);
a central console (102) communicatively coupled to the mouth scanner (101), the central console (102) is configured to:
receive the readings of the upper jaw (15) captured by the mouth scanner (101),
transmit the received readings to an orthodontist (111) for review and to provide necessary instructions on a course of treatment, and
process the received readings, and the instructions from the orthodontist (111) to display a plurality of informational data over a display screen (102a); and
a key (104) adapted to adjust the palatal expansion device (10) for correcting the upper jaw's (15) misalignment.

2. The palatal expansion support kit (100) of claim 1, wherein the mouth scanner (101) comprises at least a flexible PCB layer (101a) with copper traces in a gridline, a velostat (101b), and a rigid PCB layer (101c) with complimentary copper traces in a gridline.

3. The palatal expansion support kit (100) of claim 1, wherein the mouth scanner (101) is designed to capture the pressure points through resistances, generated from a bite force of the patient to create a digital imprint in the form of a heatmap for the upper jaw (15), and determine lateral and distal lengths of the upper jaw (15).

4. The palatal expansion support kit (100) of claim 1, wherein the central console (102) is communicatively coupled to the mouth scanner (101) using a connector (103) that's adapted for relaying the upper jaw's distal and lateral length readings from the mouth scanner (101) to the central console (102).

5. The palatal expansion support kit (100) of claim 1, wherein the instructions on the course of treatment comprises at least a palatal expansion treatment plan, the next adjustment the patient (110) needs to carry out, and provide feedback on any corrective actions.

6. The palatal expansion support kit (100) of claim 1, wherein the plurality of informational data displayed over the display screen (102a) of the central console (102) comprises at least distal and lateral length readings of the upper jaw (15), a digital imprint of the distal and lateral length readings (102d,102e), targeted distal and lateral length readings, instructions provided by the orthodontist on the course of action (102i), facilitate the patient to take a pain survey (102f), showcase the treatment progress (102f), connect to communication link (102j), synchronize (102h) the data in real time, upload the information to a cloud server (105).

7. The palatal expansion support kit (100) of claim 1, wherein the key (104) comprises an outer casing (104a), a handle (104b), an inner shaft (104d), a wheel (104e) with pinion (104f), a shoulder screw (104i), a torsion spring (104h), a linear spring (104c), a retaining ring (104g) and a screw nut (104j).

8. The palatal expansion support kit (100) of claim 1, wherein the key (104) is configured to limit the span of a rectilinear and rotational motion of the pinion (104f) during every adjustment of the palatal expansion device (10).

9. The palatal expansion support kit (100) of claim 1, wherein the central console (102) is communicatively linked to a communication device (111a) associated with the orthodontist (111) through the cloud server (105).

10. The palatal expansion support kit (100) of claim 9, wherein the cloud server (105) facilitates the central console (102) to share the distal and lateral length reading of the upper jaw (15) measured by the mouth scanner (101) with the orthodontist (111), and receive instructions from the orthodontist (111) on the course of treatment at the central console (102).

11. The palatal expansion support kit (100) of claim 7, wherein the handle (104b) when pushed moves the pinion (104f) such as to rotate the screw (13) to a one quarter of a turn amounting to ¼ mm of adjustment in distal length of the upper jaw (15).

12. A palatal expansion support kit (100), comprising:
a palatal expansion device (10) installed in an upper jaw (15), the palatal expansion device (10) comprises a pair of brackets (11,12) connected by a screw (13), wherein the screw (13) when turned leads to an expansion of the brackets (11,12) adjusting the upper jaw misalignment;
a mouth scanner (101) sized and shaped for placement into an oral cavity of a patient (110) for capturing distal and lateral length readings of the upper jaw (15);
a central console (102) communicatively coupled to the mouth scanner (101), the central console (102) is configured to:
receive the readings of the upper jaw (15) captured by the mouth scanner (101),
transmit the received readings to an orthodontist (111) for review and to provide necessary instructions on a course of treatment, and
process the received readings, and the instructions from the orthodontist (111) to display a plurality of informational data over a display screen (102a);
a key (104) adapted to adjust the palatal expansion device (10) for correcting the upper jaw's (15) misalignment; and
a cloud server (105) communicatively linked to the central console (102) and the orthodontist (111), the cloud server (105) enables the central console (102) to share the distal and lateral length reading of the upper jaw (15) measured by the mouth scanner (101) with the orthodontist (111), and receive instructions from the orthodontist (111) on the course of treatment at the central console (102).

13. The palatal expansion support kit (100) of claim 12, wherein the key (104) comprises an outer casing (104a), a handle (104b), an inner shaft (104d), a wheel (104e) with pinion (104f), a shoulder screw (104i), a torsion spring (104h), a linear spring (104c), a retaining ring (104g) and a screw nut (104j).

14. The palatal expansion support kit (100) of claim 12, wherein the key (104) is configured to limit the span of a rectilinear and rotational motion of the pinion (104f) during every adjustment of the palatal expansion device (10).

15. The palatal expansion support kit (100) of claim 13, wherein the handle (104b) when pushed moves the pinion (104f) such as to rotate the screw (13) to a one quarter of a turn amounting to ¼ mm of adjustment in distal length of the upper jaw (15).
